(19) United States
(12) Patent Application Publication
(10) Pub. No.: US 2015/0220227 A1
(43) Pub. Date: Aug. 6, 2015

(54) E-READER DEVICE WITH FEATURE TO PROVIDE CATEGORY-SPECIFIC HIGHLIGHTS OF TEXT ITEMS IN AN E-BOOK

(71) Applicant: Kobo Inc., Toronto (CA)

(72) Inventor: Benjamin Landau, Toronto (CA)

(73) Assignee: Kobo Inc., Toronto (CA)

(21) Appl. No.: 14/170,333

(22) Filed: Jan. 31, 2014

(51) Int. Cl. G06F 3/0483; G06F 3/0482; G06F 17/21

(52) U.S. Cl. CPC G06F 3/0483; G06F 17/211; G06F 3/0482

(57) ABSTRACT

A computing device that operates as an e-reader device on which category-specific highlights and annotations can be provided by a user.

### TECHNICAL FIELD

Embodiments described herein relate to an e-reader device, and more specifically, to an e-reader device with a feature to provide category-specific highlights of text items in an e-book.

### BACKGROUND

An electronic personal display is a mobile electronic device that displays information to a user. While an electronic personal display may be capable of many of the functions of a personal computer, a user can typically interact directly with an electronic personal display without the use of a keyboard that is separate from or coupled to but distinct from the electronic personal display itself. Some examples of electronic personal displays include mobile digital devices/tablet computers such (e.g., Apple iPad®, Microsoft® Surface™, Samsung Galaxy Tab® and the like), handheld multimedia smartphones (e.g., Apple iPhone®, Samsung Galaxy S®, and the like), and handheld electronic readers (e.g., Amazon Kindle®, Barnes and Noble Nook®, Kobo Aura HD, and the like).

An electronic reader, also known as an e-reader, is an electronic personal display that is used for reading electronic books (eBooks), electronic magazines, and other digital content. For example, digital content of an eBook is displayed as alphanumeric characters and/or graphic images on a display of an e-reader such that a user may read the digital content much in the same way as reading the analog content of a printed page in a paper-based book. An e-reader provides a convenient format to store, transport, and view a large collection of digital content that would otherwise potentially take up a large volume of space in traditional paper format.

In some instances, e-readers are purpose built devices designed especially to perform especially well at displaying readable content. For example, a purpose built e-reader may include a display that reduces glare, performs well in high light conditions, and/or mimics the look of text on actual paper. While such purpose built e-readers may excel at displaying content for a user to read, they may also perform other functions, such as displaying images, emitting audio, recording audio, and web surfing, among others.

There also exist numerous kinds of consumer devices that can receive services and resources from a network service. Such devices can operate applications or provide other functionality that links the device to a particular account of a specific service. For example, e-reader devices typically link to an online bookstore, and media playback devices often include applications which enable the user to access an online media library. In this context, the user accounts can enable the user to receive the full benefit and functionality of the device.

### BRIEF DESCRIPTION OF THE DRAWINGS

FIG. 1 illustrates a system for operating a computing device to enhance electronic reading activity, according to an embodiment.

FIG. 2 illustrates an example of an e-reader device or other electronic personal display device, for use with one or more embodiments described herein.

FIG. 3 illustrates an e-book device system for enabling category specific highlighting of text items in e-books and other text-based content items, according to an embodiment.

FIG. 4 illustrates a computer-implemented method for enabling category specific highlighting of e-books and other text-based content items, according to some embodiments.

FIG. 5A illustrates an annotation interface in accordance with one or more examples.

FIG. 5B illustrates an example of a category interface for use with one or more embodiments.

### DETAILED DESCRIPTION

Examples described herein provide for a computing device that operates as an e-reader device on which category-specific highlights and annotations can be provided for a user.

Still further, in some embodiments, an e-reader device provides a presentation in which text items that are provided with category-specific highlights are listed apart from a text content of an e-book. The text items provided on the presentation can be sorted, clustered or otherwise aggregated by category designations.

In an embodiment, a computing device operates to display a portion of an e-book. The computing device provides an interactive feature to receive input from the user that identifies (i) each of multiple text items from the e-book, and (ii) a category designation from multiple possible category designations for each of the multiple text items. A visual indicia is provided with each of the multiple text items as part of the e-book. The visual indicia identifies the selection of the category designation for that text item. A presentation is provided that aggregates each of the multiple text items by category designation.

One or more embodiments described herein provide that methods, techniques and actions performed by a computing device are performed programmatically, or as a computer-implemented method. Programmatically means through the use of code, or computer-executable instructions. A programmatically performed step may or may not be automatic.

One or more embodiments described herein may be implemented using programmatic modules or components. A programmatic module or component may include a program, a subroutine, a portion of a program, or software or a hardware component capable of performing one or more stated tasks or functions. As used herein, a module or component can exist on a hardware component independently of other modules or components. Alternatively, a module or component can be a shared element or process of other modules, programs or machines.

Furthermore, one or more embodiments described herein may be implemented through instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash or solid state memory (such as carried on many cell phones and consumer electronic devices) and magnetic memory. Computers, terminals, network enabled devices (e.g., mobile devices such as cell phones) are all examples of machines and devices that utilize processors, memory, and instructions stored on computer-readable mediums. Additionally, embodiments may be implemented in the form of computer-programs, or a computer usable carrier medium capable of carrying such a program.

System and Device Description

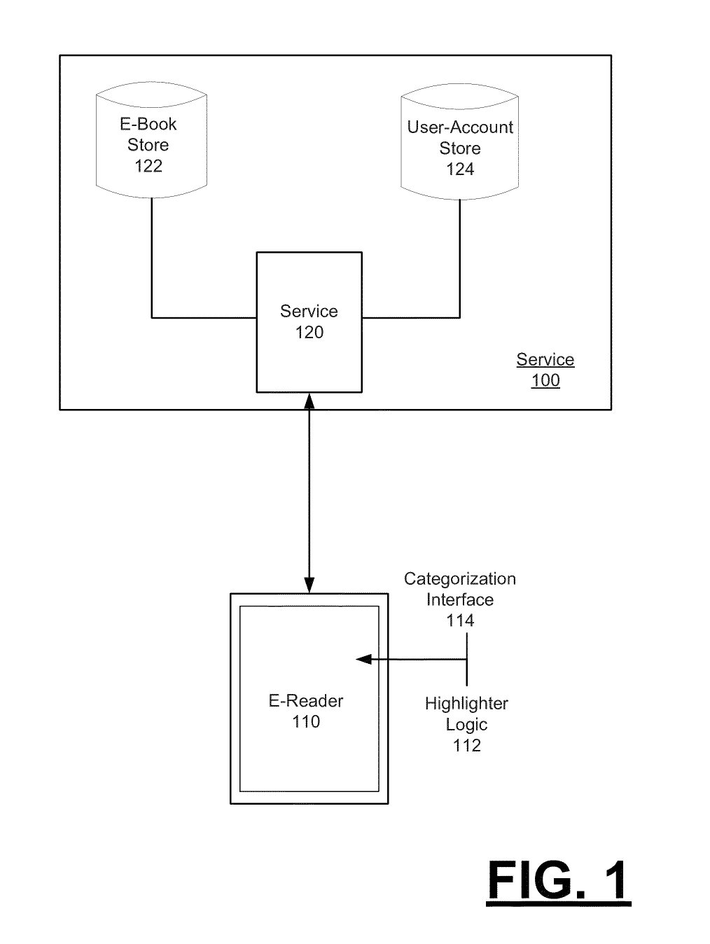

FIG. 1 illustrates a system for operating a computing device to enhance electronic reading activity, according to an embodiment. In an example of FIG. 1, system 100 includes an electronic display device, shown by way of example as an e-reader device 110, and a network service 120. The network service 120 may include multiple servers and other computing resources that provide various services in connection with one or more applications that are installed on the e-reader device 110. By way of example, in one implementation, the network service 120 can provide e-book services which communicate with the e-reader device 110. The e-book services provided through network service 120 can, for example, include services in which e-books are sold, shared, downloaded and/or stored. More generally, the network service 120 can provide various other content services, including content rendering services (e.g., streaming media) or other network-application environments or services.

The e-reader device 110 can correspond to any electronic personal display device on which applications and application resources (e.g., e-books, media files, documents) can be rendered and consumed. For example, the e-reader device 110 can correspond to a tablet or a telephony/messaging device (e.g., smart phone). In one implementation, for example, e-reader device 110 can run an e-reader application that links the device to the network service 120 and enables e-books provided through the service to be viewed and consumed. In another implementation, the e-reader device 110 can run a media playback or streaming application which receives files or streaming data from the network service 120. By way of example, the e-reader device 110 can be equipped with hardware and software to optimize certain application activities, such as rendering of electronic content (e.g., e-books). For example, the e-reader device 110 can have a tablet like form factor, although variations are possible. In some cases, the e-reader device 110 can also have an E-ink display.

In additional detail, the network service 120 can include a device interface 128, a resource store 122 and a user account store 124. The user account store 124 can associate the e-reader device 110 with a user and with an account 125. The account 125 can also be associated with one or more application resources (e.g., e-books), which can be stored in the resource store 122. As described further, the user account store 124 can retain metadata for individual accounts 125 to identify resources that have been purchased or made available for consumption for a given account. The e-reader device 110 may be associated with the user account 125, and multiple devices may be associated with the same account. As described in greater detail below, the e-reader device 110 can store resources (e.g., e-books) that are purchased or otherwise made available to the user of the e-reader device 110, as well as to archive e-books and other digital content items that have been purchased for the user account 125, but are not stored on the particular computing device.

With further reference to FIG. 1, e-reader device 110 can include annotation logic or other programming to enable text content of e-books to be highlighted and categorized. In particular, e-reader device 110 includes highlighter logic 112, to enable the user to electronically highlight text items, such as words, phrases, sentences or paragraphs. The highlighter logic 112 can provide multiple possible electronic highlights, each of which having a distinctive visual characteristic, such as a variation in color, shading or pattern. The highlighter logic 112 can be configured to associate each electronic highlight with a particular designation, and more specifically, with a category. The categories assigned to individual electronic highlights can be predetermined and/or user-defined.

The e-reader device 110 can also include a categorization interface 114. The categorization interface 114 can include logic that generates a presentation that aggregates highlighted text items, and more specifically, aggregates text items based on category designation. Thus, for example, the highlighter logic 112 can be used to generate multiple different highlights in the text content of an e-book, where individual highlights are visually distinct and associated with different categories. The categorization interface 114 can be used to display text items by category designation, so that the user can view one or multiple highlighted text items of a particular category from an e-book on a single electronic presentation. For example, as described below, the user may utilize a blue highlight to electronically highlight text items that are relevant to the category of “plot”, and then use the categorization interface 114 to view all of the text items that were highlighted in the color associated with the designation “plot.”

In variations, the presentation provided by the categorization interface 114 is displayed as a component of the e-book where the electronic highlights and/or other annotations are made. For example, the presentation generated by the categorization interface 114 can correspond to a page, separate overlay or window, or tab that appends or otherwise accompanies the e-book.

Still further, in another variation, the categorization interface 114 can aggregate text items by category for multiple different e-books and/or other text content sources. For example, the user can designate a blue electronic highlighter to refer to a category regarding “historical facts,” and then selectively use the electronic blue highlighter on multiple e-books pertaining to historical fiction.

At each instance that the user encounters a historical fact, the user can highlight that text in the appropriate blue highlighter. At a subsequent time, the categorization interface 114 can be used to display to the user those text items that were marked in blue, designating a category of “historical facts.”

To further examples provided, the user can highlight color for another category, such as yellow highlights for text items that pertain to a particular character. The categorization interface 114 can display selected text items for multiple categories at one time, and aggregate text items by category in accordance with an organization structure. For example, multiple text items highlighted by common color throughout the e-book can be grouped and displayed together on a presentation generated by the categorization interface 114, while other text items highlighted in a different color are displayed on the same presentation but as a different grouping.

Hardware Description

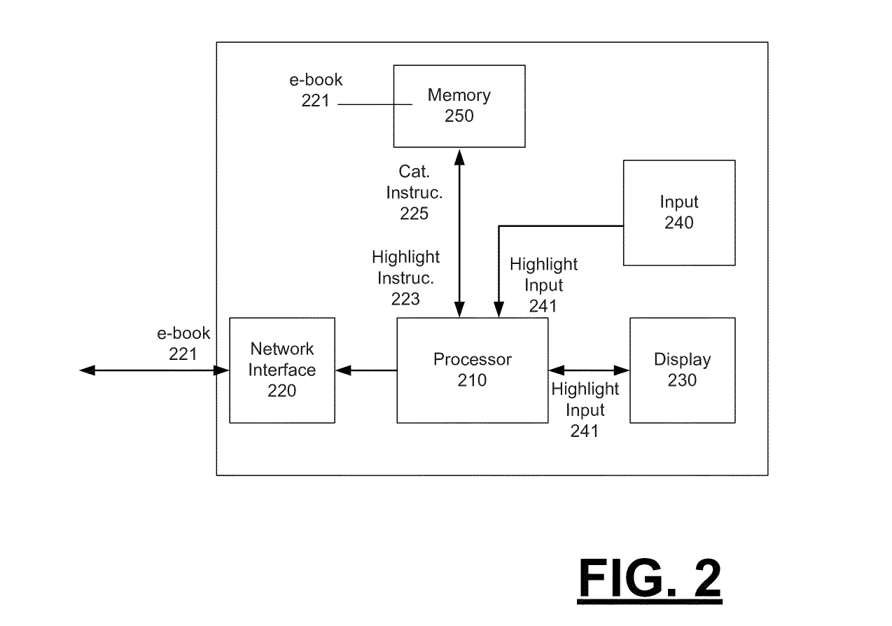

FIG. 2 illustrates an example of an e-reader device or other electronic personal display device, for use with one or more embodiments described herein. In an example of FIG. 2, an e-reader device 200 can correspond to, for example, a device, such as also shown by an example of FIG. 1. With reference to FIG. 2, e-reader device 200 includes a processor 210, a network interface 220, a display 230, one or more input mechanisms 240, and a memory 250.

The processor 210 can implement functionality using instructions stored in the memory 250. Additionally, in some implementations, the processor 210 utilizes the network interface 220 to communicate with the network service 120 (see FIG. 1). More specifically, the e-reader device 200 can access the network service 120 to receive various kinds of resources (e.g., digital content items such as e-books, configuration files, account information), as well as to provide information (e.g., user account information, service requests etc.). For example, e-reader device 200 can receive application resources, such as e-books 221 or media files that the user elects to purchase or otherwise download from the network service 120. The application resources that are downloaded onto the e-reader device 200 can be stored in the memory 250.

In some implementations, the display 230 can correspond to, for example, a liquid crystal display (LCD) or light emitting diode (LED) display that illuminates in order to provide content generated from processor 210. In some implementations, the display 230 can be touch-sensitive. In some variations, the display 230 can correspond to an electronic paper type display, which mimic conventional paper in the manner in which they display content. Examples of such display technologies include electrophoretic displays, electrowetting displays, and electrofluidic displays.

The processor 210 can receive input from various sources, including from input mechanisms 240 (e.g., buttons or switches, microphone, keyboard), the display 230 (e.g., soft buttons or keyboard) or other input mechanisms (accessory devices).

According to some embodiments, the memory 250 stores instructions 223 for providing the highlighter logic 112 (see FIG. 1) and instructions 225 for providing the categorization interface 114. The processor 210 executes instructions 223 to implement highlighter logic 112. A user can provide highlight input 241 using the input mechanism 240. The highlight input 241 can identify text items that an e-book to 21 for highlight. The instructions for the highlighter logic 112 can enable the user to select a color as part of the highlight input 241. In selecting the color, the user can specify a category designation. For example, the processor 210 can pre-associate a specific highlight color (or other characteristics) with a corresponding category designation. The highlight input 241 can specify the text item that is to be highlighted, as well as the color of the electronic highlight. By specifying color, the user can also designate the categorization for the selected text item.

The processor 210 can execute the categorization instructions 225 in order to generate categorization interface 114. The categorization interface 114 can display text items that have been designated (by the user specifying a highlight color when electronically highlighting) for individual categories. In particular, the processor 210 can execute the categorization instructions 225 in order to aggregate or cluster text items that have been marked by the electronic highlighter (e.g., the selection of a particular color or other aspect by the user via the highlighter input 241). In this way, the processor 210 can generate the categorization interface 114 to display highlighted text items in a manner that reflects the category designation of each of the individual text items.

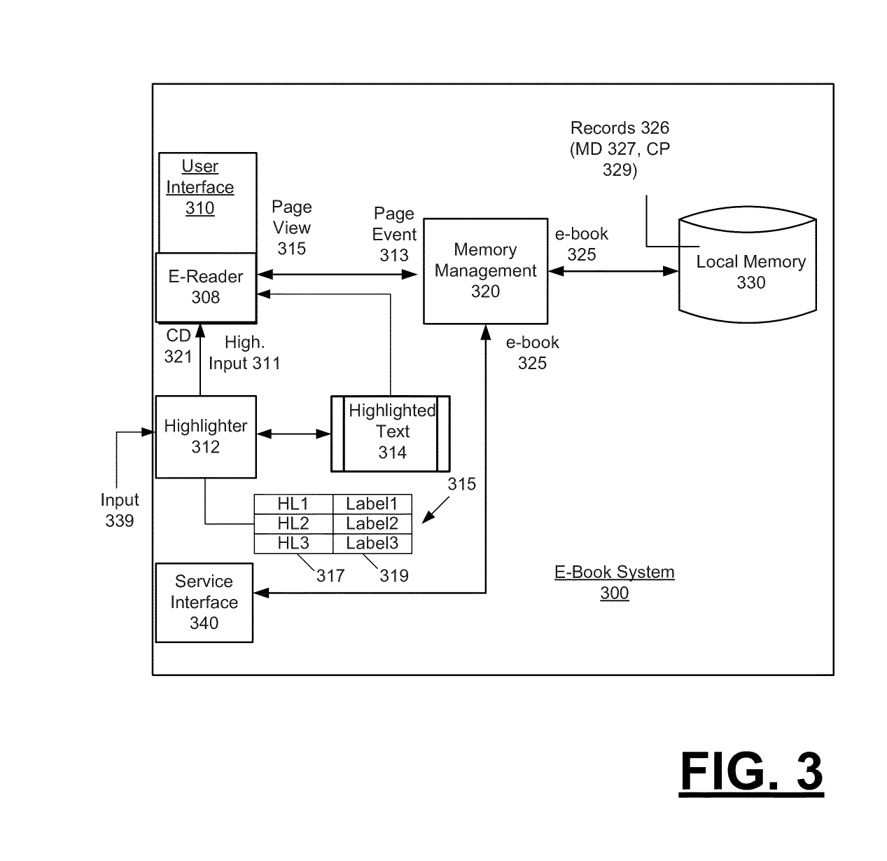

FIG. 3 illustrates an e-book device system for enabling category specific highlighting of text items in e-books and other text-based content items, according to an embodiment. In reference to FIG. 3, a system 300 implements programmatic components for communicating with an e-book service (such as network service 120, shown in FIG. 1), as well as for enabling functionality for viewing and accessing e-books utilized by an account associated with the e-reader device 110 (see FIG. 1 or FIG. 2). In some embodiments, the system 300 can be implemented as an application that runs on an e-reader device, such as shown with examples of FIG. 1 or FIG. 2.

In an example of FIG. 3, system 300 includes a user interface 310, a memory management module 320, a local memory 330, and a service interface 340. Some or all of the programmatic components shown with the computing system 300 can be provided in part as operating system-level components. Alternatively, the programmatic components shown with the computing system 300 can be provided as part of an application that runs on, for example, the e-reader device 110. For example, the user can download an application onto the device that is operated as the e-reader device 110, in order to obtain functionality such as described with an example of FIG. 3. For example, the user can download an application onto an e-reader device, to obtain functionality such as described herein as well as to communicate with the network service 120. Alternatively, an application can be embedded or otherwise preinstalled with other programmatic elements for providing functionality such as described with system 300.

The service interface 340 includes application logic which enables the e-reader device 110 to use, for example, a wireless Internet connection to connect to the network service 120 (see FIG. 1). In connecting with the service, the service interface 340 can transmit data that enables the network service 120 to identify the e-reader device 110 on which system 300 is implemented, so that the network service 120 can determine the account that is associated with the particular e-reader device. The service interface 340 can be used to retrieve e-books 325 from the network service 120. For example, in identifying the e-reader device 110 of system 300 to the network service 120, the network service may be able to procure payment information (e.g., stored credit card information) that can be used to charge the users account when the user purchases a new e-book from the service. Each e-book can correspond to a literary work having a pagination format. Optionally, some e-books may have chapter designations, as well as content that corresponds to graphics or images (e.g., such as in the case of magazines or comic books). Individual e-books 325 can also include metadata 327, such as imagery provided as a cover for the e-book when the e-book is marketed (e.g. similar to the manner in which a conventional hardbound book would be marketed in a retail store). In one implementation, the network service 120 can retrieve or otherwise identify the imagery and other metadata 327 of individual e-books from publisher sources.

In identifying the e-reader device of system 300, the network service 120 can identify what e-books belong to the account associated with the particular device. The e-books that are transmitted to the e-reader device of system 300 include those e-books that are purchased from the device, or those e-books that the user requested to download. In variations, e-books can be automatically downloaded to the device in response to occurrence of certain conditions. For example, the user can purchase an e-book on another device, and then subsequently connect to the network service 120 via the e-reader device 110 to automatically receive their previously purchased e-book. Alternatively, as another example, network service 120 can be configured to push e-books to the e-reader device 110 of system 300, based on, for example, user account settings, subscription plans and rules, and various other business logic considerations.

Additionally, the service interface 340 can include processes for automatically receiving updates from a network service 120. The update can include programmatic updates, including updates to software components on the e-reader device 110, as well as updates to lists, download of e-books that the user may have purchased on another device of the same account, recommendations from the network as to what a given user may want to purchase or view, and/or various other data that can be either generally provided to the user of the network service or specifically provided for to the particular account or user.

According to some embodiments, the local memory 330 stores each e-book as a record 326 that includes metadata 327 and content 329 (e.g., page content). The management module 320 can retrieve portions of individual e-books for purpose of rendering e-books via the user interface 310.

In an example of FIG. 3, the user interface 310 can include or operate in connection with a highlighter component 312. The highlighter component 312 can correspond to an interactive feature that the user can operate, in order to provide highlight input 339. The highlight input 339 can identify text that the user wants the highlight, as well as the particular highlighter (or other visual indicia) that the user wants to use.

In some embodiments, the highlighter component 312 is associated with a data item 315 (e.g. table) that associates individually distinct electronic highlights with corresponding category designations. In particular, the electronic highlights can be made distinct in appearance by way of variations in color, shading, patterning or other visual indicia. The data item 315 can be established through user input, provided through, for example, the highlighter component 312. In this way, the data item 315 associates individual highlighters 317 with corresponding category designations 319.

In some examples, highlighted 312 can include a feature to enable the user to define a category designation (e.g., specify a label for a category), and further to associate a defined highlighter (as distinguished by a visual characteristic such as color) with a particular category. For example, the user can define a designated category (“historical facts”), and then link a particular highlighter (e.g. a color or a distinct shading) with that highlighter. In one implementation, the association between the highlighter and the category designation can be made by way of the user providing input through the highlighter component 312. For example, the user can operate a menu or other functional screen provided through the highlighter component to select a particular highlighter, and further to enter a label (e.g., “historical facts”) that defines the category designation.

Alternatively, the category designations can be set by default, such as by using preset category definitions. Still further, in some implementations, the user can define category designations through remote source. For example, the user can operate a second e-reader device that is linked to a common account, to enter input that identifies category designations and associates individual category designations with the particular highlighter. The highlighter and category designations can be saved on the network service 120, and then synchronized with the e-reader device 110 at an appropriate time (e.g., such as when the user opens an e-book that has been highlighted on another device). Still further, the user can use a webpage or other interface to enter account information, and the information can correspond to the user's definition of category designations and/or associations between category designations and distinct highlighters. In this way, the network service 120 can maintain information about the user's category designations and/or associations with individual highlighters, and this information can be synchronized or otherwise communicated with the multiple devices that are associated with users account. The category-specific designations for highlighters can correspond to information that is either associated with a particular e-book, or alternatively maintained globally for multiple e-books that are linked to the user account.

The highlighter component 312 can specify highlighter input 311 for e-reader component 308. The highlighter input 311 can correspond to metadata that identifies the text item that is to be highlighted, and the particular highlighter that is selected for the text item. The e-reader component 308 can utilize the highlighter input 311 to generate different highlights (as specified by the user) on the text content of a given e-book. In one implementation, highlighter component 312 receives input 319 while the user is reading a particular e-book, communicates a corresponding highlighter input 311 to the e-reader component 308, which in turn highlights the corresponding text item identified by the user input 319 in selected highlighted form.

Additionally, highlighter input 311 can be recorded as part of the metadata 327 for the particular e-book. The memory management module 320 can retrieve the highlighter input 311 as metadata 327 stored with the record 326, and communicates the metadata to the e-reader component 308 when the book is being read. In this way, text items are highlighted on the e-book based on prior reading session of the user.

In some embodiments, text items identified by the input 329 can be recorded as highlighted data store 314. The highlighted text data store 314 can also record what highlight was used for the particular text item. Still further, the category designation for the particular highlighter can also be recorded with the highlighted data store 314. The highlighted text data store 314 can be linked with the particular e-book.

The user can provide input via the highlighter component 312 in order to display a category interface 321 as part of the reading environment provided through the e-reader component 308. The category interface 321 can be generated from, for example, the highlighted data store 314. For example, the category interface 321 can be provided as a page of an e-book, an overlay panel, the adjacent panel, or other content item that is provided with or in proximity to text content of the e-book being displayed through the e-reader component 308. The category interface 321 can access highlighted data store 314 to display text items from the e-book being displayed through the e-reader component 308. The highlighted text items can be provided with a categorical organization structure when included with the category interface 321. For example, the highlighted text items can be sorted or otherwise grouped by category designation (e.g., by highlight color). Thus, for example, the user can utilize the category interface 321 in order to view, under a particular category designation, text items corresponding to sentences, words or phrases that the user highlighted in a particular color to designate a corresponding category.

Methodology

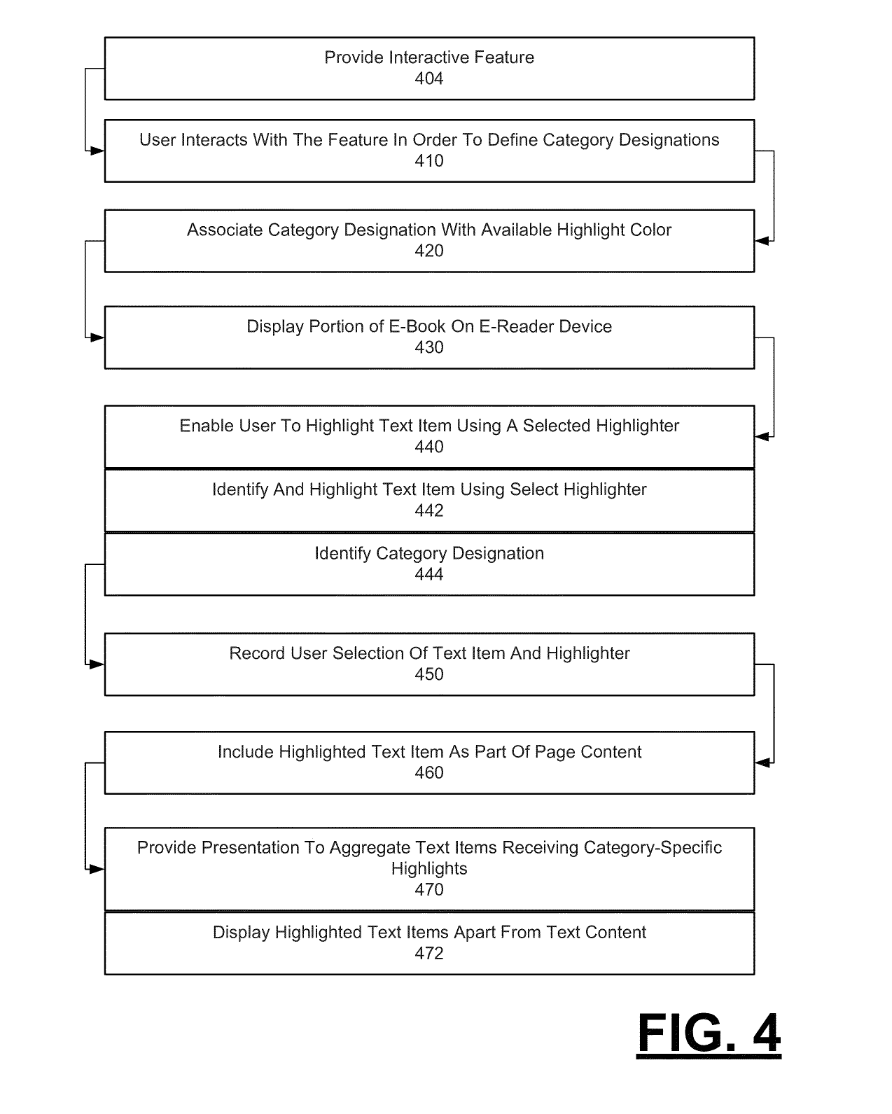

FIG. 4 illustrates a computer-implemented method for enabling category specific highlighting of e-books and other text-based content items, according to some embodiments. A method such as described by an example of FIG. 4 may be implemented using components such as described with an example of FIG. 1, FIG. 2 or FIG. 3. Accordingly, reference may be made to elements of prior examples for purpose of illustrating suitable components for performing a step or sub-step being described.

With reference to FIG. 4, in e-reader device 110 can be provided with an interactive annotation feature that enables the user to highlight text, and more specifically, to select a particular electronic highlighter (404). Multiple electronic highlighters can be provided through the interactive feature. For example, a set of multiple highlighters can include highlighters of different color, or highlighters of different shading. In one implementation, the interactive feature can correspond to a software based mechanism, such as provided with highlighter logic 112 (see FIG. 1) or highlighter component 312 (see FIG. 3).

The user can interact with the feature in order to define category designations (410). The category designations can be defined by labels, which the user can generate using alphanumeric input.

The user can also interact with the feature in order to provide input that associates a particular category designation with an available highlighter color (420). For example, the user can specify selection input that associates a particular highlighter with a label the user created as a category designation.

During the reading session, a portion of an e-book is displayed on an e-reader device 110 (430). The portion of the e-book can correspond to a page, portion of a page, or multiple pages when multipage view is used.

In connection with the displayed portion, the interactive feature enables the user to highlight a text item from the e-book using a selected highlighter (440). The text item identified by the user in the portion of the displayed e-book is highlighted, using a select electronic highlighter (442). For example, the user can interact with the e-reader device 110 by touching the screen to select a particular highlighter, and then touching the screen again at a location where the text item the user wants to highlight is displayed. A category designation is identified for the selected text item based on the highlighter selected by the user (444).

The user selection of highlighter and text item is received and recorded on the e-reader device 110 (450). With reference to FIG. 3, in one implementation, metadata identifying the highlighter and the selected text item is stored as part of the metadata 327 for the record 326 of the corresponding e-book. The metadata 327 can note the location of the highlight within an e-book, as well as the highlighter that is used by the user in order to generate the highlight.

Subsequently, page content on which the text item appears can include the highlight for the text item (460). In one implementation, the user can close the e-book, and then returned to it at a later time to see the highlight. Still further, the user can read or flip through multiple pages the e-book while highlighting, and then return to prior pages in order to see what was highlighted at an earlier time. Still further, in some variations, the metadata corresponding to the highlight items can be communicated to the network service 120, and then stored in the user account. When the e-book is accessed from another device linked to the same account, the different highlights (along with the corresponding categorizations) can be rendered on the other e-book device.

According to embodiments, a presentation for aggregating the text items receiving category-specific highlights is provided (470). In one embodiment, a presentation is provided that displays the highlighted text items apart from the text content of the e-book using an organizational structure such as clustering or sorting (472). The presentation can be provided as part of the e-book. For example, the presentation can be generated from metadata that is stored as part of the e-book on the e-reader device 110, or on the network service 120 (e.g., to share highlighted text across multiple devices). Additionally, the highlighted text items can be aggregated on a panel, window or overlay that accompanies or is part of the e-book when the e-book is opened on the e-reader device 110. The presentation can identify the designated category for each highlighter by, for example, its label and/or color (e.g., correspond to the color of the highlighter for each category). Furthermore, entries corresponding to text items for each highlighter can be provided in clustered form with each designated category. For example, a category can be displayed as a line item on the presentation, and under the line item, text items marked by the highlighter for that category can be identified. The text items can be identified by their content in their respective entirety, or alternatively, by a partial listing. Additionally, the text item can include a link or identifier to the location in the e-book where to text item appears.

### EXAMPLES

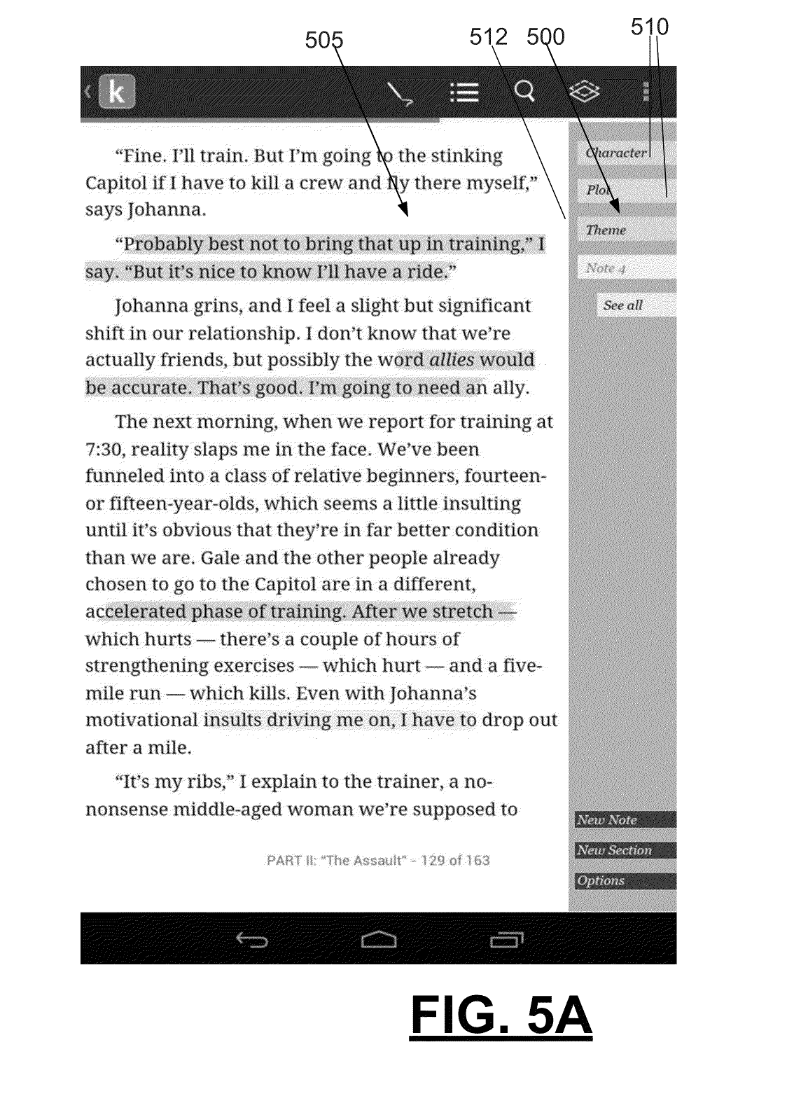

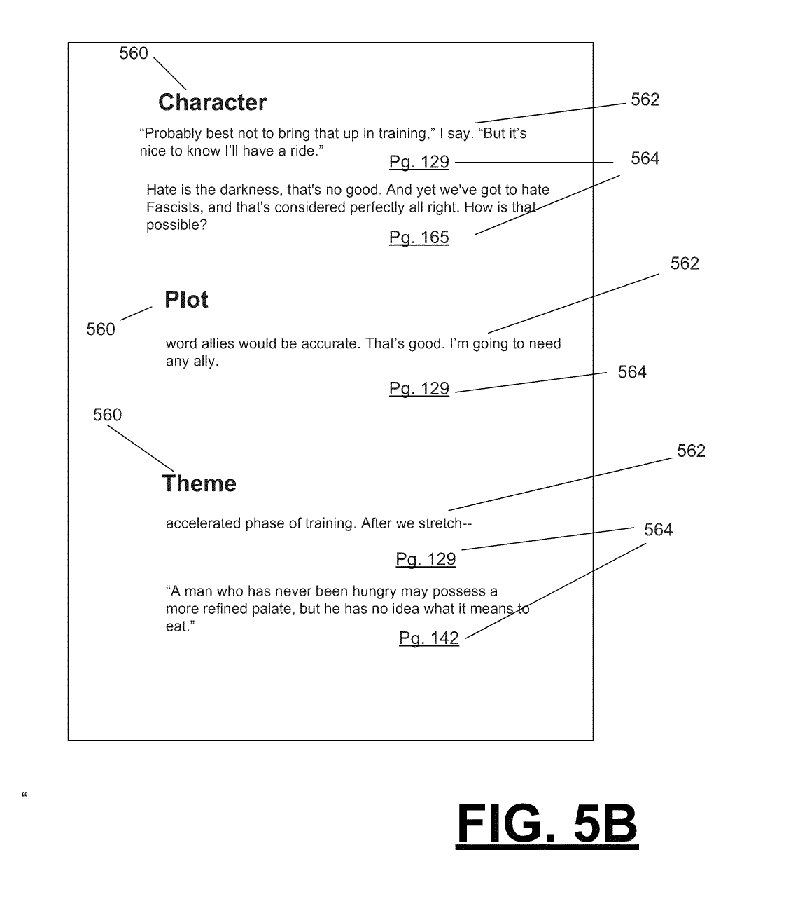

FIG. 5A illustrates an annotation interface in accordance with one or more examples. The annotation interface 500 enables the user to highlight select text items appearing on a given portion of the text content 505 for an e-book. The annotation interface 500 can enable a user to specify category designations 510. Each category designation 510 can correspond to a label. For example, the label (e.g., “character”, “plot”, “theme”) of each category designation 510 can be created and defined by the user. As shown with an example, each category designation 510 can be assigned a corresponding color. The user can highlight text items using the highlight color that is associated with a category designation that the user deems to be most relevant to the particular text item.

In some variations, a border 512 of the text content 505 can be shown as tabs, corresponding to category designations. Each tab can locate within the e-book a corresponding highlighted text item for a corresponding category designation. The tabs can be generated to visually protrude from the boundary 512 of the text content. The tabs can be selectable in order to navigate the e-book to a location within the e-book where a corresponding highlighted text item is provided. Additionally, the tabs can be provided with visual indicia to match the colors of the available highlights.

FIG. 5B illustrates an example of a category interface for use with one or more embodiments. In particular, a category interface 550 list category designations 560 that the user has defined for use with a particular e-book. The category designations 560 can each mark one or more (or a cluster) of text items 562 that have previously been highlighted by the user in the highlight color associated with the particular category. Each category designation 560 can also include an identifier to a portion of the e-book that contains the text item. For example, in an example of FIG. 5B, the category designations for “Character” and “Theme” have multiple sentences/phrases from different locations within the e-book. Still as another example, each category designation 560 can include the page number where the text item appears. Additionally, identifier 564 can be active, meaning the user can select the identifier in order to automatically navigate to the page (and portion thereof) where the text item appears. Each text item can have its own identifier within the cluster (if such exists for the category designation).

Embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A non-transitory computer-readable medium that stores instructions for operating a computing device, the instructions being executable by one or more processors to perform operations that include:
displaying a portion of an e-book;
providing an interactive feature to receive input from a user that identifies (i) each of multiple text items from the e-book, and (ii) a category designation from multiple possible category designations for each of the multiple text items;
providing, as part of the e-book, visual indicia with each of the multiple text items, the visual indicia identifying the category designation for that text item; and
providing a presentation that aggregates each of the multiple text items by category designation.

2. The computer-readable medium of claim 1, wherein providing visual indicia includes providing a highlight that includes a characteristic that is indicative of a corresponding category designation from the multiple possible category designations.

3. The computer-readable medium of claim 2, wherein the characteristic includes at least one of a color, shading or pattern.

4. The computer-readable medium of claim 1, wherein providing the presentation includes providing a panel over or adjacent to a text content of the e-book, the panel including a label and a corresponding visual indicia for each of at least some of the multiple possible category designations.

5. The computer-readable medium of claim 4, wherein providing the presentation is performed in response a user interacting with the panel.

6. The computer-readable medium of claim 1, wherein at least one or more of the multiple possible category designations is user-defined.

7. The computer-readable medium of claim 1, wherein the visual indicia of at least one or more of the multiple possible category designations is selected by the user.

8. The computer-readable medium of claim 1, wherein providing the presentation includes displaying a label for each of the multiple possible category designations along with one or more text items identified by the user for that category designation.

9. The computer-readable medium of claim 1, further comprising instructions for displaying one or more tabs on an edge of a text content of the e-book, each tab corresponding to one of the multiple possible category designations and including the visual indicia for the corresponding one of the multiple possible category designations.

10. The computer-readable medium of claim 9, further comprising instructions for responding to a selection of each of the one or more tabs by navigating a text content of the e-book to a location in the e-book where at least one of the multiple text items is provided with visual indicia corresponding to the category designation of the tab of the selection.

11. The computer-readable medium of 1, wherein providing the presentation includes clustering each text item with visual indicia of a particular category designation under a label for that category designation.

12. The computer-readable medium of 1, further comprising providing an active link with each text item provided with the presentation, the active link programmatically locating the text item within the e-book.

13. A computer system comprising:
a memory that stores a set of instructions;
a display screen;
one or more processors that use instructions from the memory to:
display a portion of an e-book;
provide an interactive feature to receive input from the user that identifies (i) each of multiple text items from the e-book, and (ii) a category designation from multiple possible category designations for each of the multiple text items;
provide, as part of the e-book, visual indicia with each of the multiple text items, the visual indicia identifying the category designation for that text item; and
provide a presentation that aggregates each of the multiple text items by category designation.

14. The computer system of claim 13, wherein the one or more processors provide visual indicia by providing a highlight that includes a characteristic that is indicative of a corresponding category designation from the multiple possible category designations.

15. The computer system of claim 14, wherein the characteristic includes at least one of a color, shading or pattern.

16. The computer system of claim 13, wherein the one or more processors provide the presentation as a panel that is displayed over or adjacent to a text content of the e-book, wherein the panel includes a label and a corresponding visual indicia for each of at least some of the multiple category designations.

17. The computer system of claim 16, wherein the one or more processors display the presentation in response a user interacting with the panel.

18. The computer system of claim 13, wherein at least one or more of the multiple possible category designations is user-defined.

19. The computer system 13, wherein the one or more processors provide the presentation by displaying a label for each of the multiple possible category designations, along with one or more text items identified by the user for that category designation.

20. A method for operating a computing device, the method being implemented by one or more processors and comprising:
displaying a portion of an e-book;
providing an interactive feature to receive input from the user that identifies (i) each of multiple text items from the e-book, and (ii) a category designation from multiple possible category designations for each of the multiple text items;
providing, as part of the e-book, visual indicia with each of the multiple text items, the visual indicia identifying the category designation for that text item; and
providing a presentation that aggregates each of the multiple text items by category designation.
